(19) United States
(12) Patent Application Publication
(10) Pub. No.: US 2026/0241725 A1
(43) Pub. Date: Aug. 20, 2026

(54) CONVEYANCE DEVICE AND RECORDING DEVICE

(71) Applicant: SEIKO EPSON CORPORATION, Tokyo (JP)

(72) Inventor: Yusuke SAITO, YAMAGATA-MURA (JP)

(21) Appl. No.: 19/544,421

(22) Filed: Feb. 19, 2026

(30) Foreign Application Priority Data
Feb. 19, 2025 (JP) 2025-024951

(51) Int. Cl. B41J 15/16; B41J 15/04; B41J 29/10

(52) U.S. Cl. CPC B41J 15/165; B41J 15/046; B41J 15/048; B41J 29/10

(57) ABSTRACT

A conveyance device according to the present disclosure includes: a feeding unit that rotatably holds a roll body formed of a wound medium and can feed the medium from the roll body; a conveyance unit that intermittently conveys the medium fed from the roll body in a conveyance direction; a tension bar that is disposed to be movable between the feeding unit and the conveyance unit in a conveyance path along which the medium is conveyed, and presses the medium to apply a tension thereto; a tension bar moving unit that moves the tension bar; and a vibration unit that vibrates the tension bar.

The present application is based on, and claims priority from JP Application Serial Number 2025-024951, filed February 19, 2025, the disclosure of which is hereby incorporated by reference herein in its entirety.

### BACKGROUND

### 1. Technical Field

The present disclosure relates to a conveyance device and a recording device.

### 2. Related Art

An example of the related art of the device of this type is disclosed in JP-A-2023-022374. JP-A-2023-022374 discloses the following.

A supply bar drive mechanism adjusts the driving force applied to a supply bar support member and thus adjusts the tension applied to a medium as the supply bar member swings.

JP-A-2023-022374 is an example of the related art.

In JP-A-2023-022374, when the supply bar member swings, a noise may be generated due to friction with the medium, and therefore there is room for improvement in this respect.

### SUMMARY

According to an aspect of the present disclosure, a conveyance device includes: a feeding unit that rotatably holds a roll body formed of a wound medium and can feed the medium from the roll body; a conveyance unit that intermittently conveys the medium fed from the roll body in a conveyance direction; a tension bar that is disposed to be movable between the feeding unit and the conveyance unit in a conveyance path along which the medium is conveyed, and presses the medium to apply a tension thereto; a tension bar moving unit that moves the tension bar; and a vibration unit that vibrates the tension bar.

According to another aspect of the present disclosure, a recording device includes: a recording unit that performs recording on a conveyed medium; and a conveyance device that is located upstream of the recording unit in a conveyance direction and conveys the medium toward the recording unit, and the conveyance device is the conveyance device according to any one of first to eighth aspects described later.

### BRIEF DESCRIPTION OF THE DRAWINGS

FIG. 1 is a schematic side view of a schematic configuration of a recording device including a conveyance device according to Embodiment 1.

FIG. 2 is a plan view of the tension applying unit according to Embodiment 1.

FIG. 3 is an enlarged schematic side view of a conveyance device according to Embodiments 1, 2, and 3.

FIG. 4 is a block diagram of a control unit according to Embodiments 1, 2, and 3.

### DESCRIPTION OF EMBODIMENTS

First, an overview of the present disclosure will be described.

A conveyance device according to a first aspect of the present disclosure includes: a feeding unit that rotatably holds a roll body formed of a wound medium and can feed the medium from the roll body; a conveyance unit that intermittently conveys the medium fed from the roll body in a conveyance direction; a tension bar that is disposed to be movable between the feeding unit and the conveyance unit in a conveyance path along which the medium is conveyed, and presses the medium to apply a tension thereto; a tension bar moving unit that moves the tension bar; and a vibration unit that vibrates the tension bar.

When the medium is conveyed in a state where the tension bar is in contact with the conveyed medium to apply a tension thereto, an abnormal noise may be generated from a part where the tension bar and the medium slide against each other.

According to this aspect, the conveyance device includes the tension bar that is disposed to be movable between the feeding unit and the conveyance unit in the conveyance path along which the medium is conveyed, and presses the medium to apply a tension thereto, and the tension bar moving unit that moves the tension bar. The conveyance device also includes the vibration unit that vibrates the tension bar. Thus, when the tension bar slides on the medium, the generation of the abnormal noise due to the vibration of the tension bar by the vibration unit can be suppressed.

A conveyance device according to a second aspect of the present disclosure is the conveyance device according to the first aspect, further including a control unit that controls each operation of the feeding unit, the conveyance unit, the tension bar moving unit, and the vibration unit, and the control unit drives the vibration unit to vibrate the tension bar, based on vibration timing information designating a timing of vibrating the tension bar.

According to this aspect, the control unit is configured to drive the vibration unit to vibrate the tension bar, based on vibration timing information designating the timing of vibrating the tension bar. Thus, the generation of the abnormal noise can be suppressed by vibrating the tension bar at a timing when in the state where the abnormal sound is generated, that is, at an appropriate timing. Also, the generation of the abnormal noise can be suppressed without vibrating the tension bar unnecessarily.

A conveyance device according to a third aspect of the present disclosure is the conveyance device according to the second aspect in which the vibration timing information is position information in a direction of movement of the moving tension bar.

According to this aspect, the vibration timing information is the position information of the moving tension bar in the direction of movement. Thus, the generation of the abnormal noise can be suppressed by vibrating the tension bar at an appropriate timing, based on the position information of the tension bar.

A conveyance device according to a fourth aspect of the present disclosure is the conveyance device according to the third aspect in which the tension bar moving unit includes a rotating part and a rotary encoder, and the position information is acquired via the rotary encoder.

According to this aspect, since the position information is acquired via the rotary encoder, the position information can be acquired with a simple structure.

A conveyance device according to a fifth aspect of the present disclosure is the conveyance device according to the second aspect in which the vibration timing information is speed information of the moving tension bar.

According to this aspect, the vibration timing information is the speed information of the moving tension bar. Thus, the generation of the abnormal noise can be suppressed by vibrating the tension bar at an appropriate timing, based on the speed information of the tension bar.

A conveyance device according to a sixth aspect of the present disclosure is the conveyance device according to the fifth aspect in which the tension bar moving unit includes a rotating part and a rotary encoder, and the speed information is acquired via the rotary encoder.

According to this aspect, since the speed information is acquired via the rotary encoder, the speed information can be acquired with a simple structure.

A conveyance device according to a seventh aspect of the present disclosure is the conveyance device according to the second aspect in which the control unit is configured to execute an operation of starting a downward movement of the tension bar located at an upper position by the tension bar moving unit after the conveyance unit stops, and moving the tension bar located at a lower position upward by the tension bar moving unit after the conveyance unit resumes the conveyance of the medium, and the vibration timing information is (1) a first predetermined time after the conveyance unit stops and immediately before the tension bar reaches the lower position, and (2) a second predetermined time after the conveyance unit resumes the conveyance of the medium and immediately after the tension bar starts to move upward from the lower position.

According to this aspect, the vibration timing information is (1) the first predetermined time after the conveyance unit stops and immediately before the tension bar reaches the lower position, and (2) the second predetermined time after the conveyance unit resumes the conveyance of the medium and immediately after the tension bar starts to move upward from the lower position. Thus, the generation of the abnormal noise can be suppressed by vibrating the tension bar at an appropriate timing without using the rotary encoder.

A conveyance device according to an eighth aspect of the present disclosure is the conveyance device according to the second aspect in which a vibration transmission suppression member is provided between the conveyance unit and the tension bar.

Note that this aspect can also be dependent from any one of the third to seventh aspects.

According to this aspect, since the vibration transmission suppression member is provided between the conveyance unit and the tension bar, the vibration can be prevented from being transmitted to the conveyance unit and therefore the conveyance accuracy of the conveyance unit can be maintained.

A recording device according to a ninth aspect of the present disclosure includes: a recording unit that performs recording on a conveyed medium; and a conveyance device that is located upstream of the recording unit in a conveyance direction and conveys the medium toward the recording unit, and the conveyance device is the conveyance device according to any one of the first to eighth aspects.

According to this aspect, the recording device can achieve effects similar to the effects described in any one of the first to eighth aspects.

### Embodiments

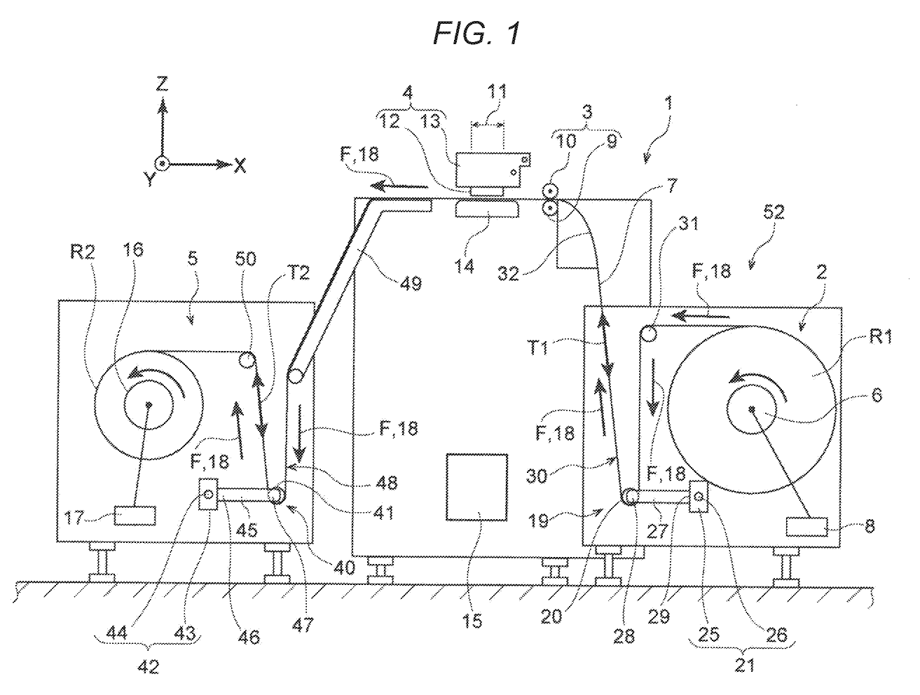

Hereinafter, a conveyance device according to embodiments of the present disclosure and a recording device including the conveyance device will be specifically described with reference to FIGS. 1 to 4. Here, a case where the recording device is an inkjet printer will be described.

In the description below, three axes orthogonal to one another are respectively defined as an X axis, a Y axis, and a Z axis as illustrated in the illustrations. A direction indicated by an arrow along the three axes (X, Y, and Z) is a + direction along the axes, and the opposite direction thereof is a - direction. The Z-axis direction is equivalent to a vertical direction, that is, a direction in which the gravity acts, the +Z direction indicates a vertically upward direction and the -Z direction indicates a vertically downward direction. The X-axis direction and the Y-axis direction correspond to a horizontal direction. The +X direction indicates a right direction of the recording device, and the -X direction indicates a left direction of the recording device. The +Y direction indicates a front direction of the recording device and a -Y direction indicates a rear direction of the recording device.

### Description of Overview of Recording Device

As illustrated in FIG. 1, a recording device 1 according to the present embodiment includes a feeding unit 2, a conveyance unit 3, a recording unit 4, a take-up unit 5, and a control unit 15.

The feeding unit 2 has a support shaft 6, and a long medium 7 is set on the support shaft 6 in a state of a roll body R1. The feeding unit 2 rotates the support shaft 6 to rotate the roll body R1, and thus feeds the medium 7 in a conveyance direction F.

The support shaft 6 rotates as a rotational force is applied thereto by a rotation mechanism 8.

The rotation mechanism 8 is driven by motive power transmitted from a motor, not illustrated, according to a control signal of the control unit 15.

The conveyance unit 3 intermittently conveys the medium 7 in the conveyance direction F. Here, the conveyance unit 3 nips the medium 7 between a pair of a drive roller 9 and a driven roller 10 and thus conveys the medium 7. A dimension L of the medium 7 by which the conveyance unit 3 feeds the medium 7 per feed in the intermittent conveyance is a dimension by which the recording unit 4 can perform recording per reciprocation, described later.

The drive roller 9 is driven as motive power is transmitted thereto from a motor, not illustrated, according to a control signal of the control unit 15. That is, the conveyance unit 3 intermittently conveys the medium 7.

The recording unit 4 ejects an ink from a recording head 12 to the fed medium 7 in a recording execution area 11 and thus performs recording. The recording head 12 is mounted on a carriage 13. The carriage 13 reciprocates in the width direction (Y-axis direction) of the medium 7 intersecting the conveyance direction F. When the conveyance unit 3 is stopped and the medium 7 is also stopped, the recording unit 4 performs recording by ejecting the ink while reciprocating.

The recording unit 4 executes a recording operation by the reciprocation and the ink ejection in accordance with a control signal from the control unit 15. In the recording execution area 11, the medium 7 is supported by a platen 14.

The take-up unit 5 includes a support shaft 16. The long medium 7 is set in a state where a distal end part thereof is fixed to the support shaft 16. The take-up unit 5 rotates the support shaft 16 and thus winds up the medium 7 to form a roll body R2. The support shaft 16 rotates as a rotational force is applied thereto by a rotation mechanism 17.

The rotation mechanism 17 is driven by motive power transmitted from a motor, not illustrated, according to a control signal of the control unit 15.

### Tension Applying Unit on Feeding Unit Side

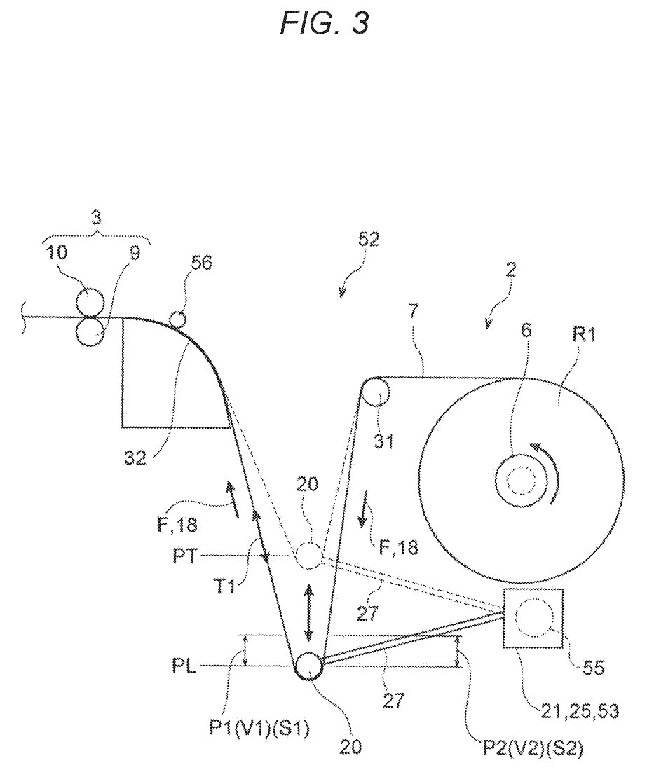

Further, a tension applying unit 19 is provided in a conveyance path 18 between the feeding unit 2 and the conveyance unit 3. The tension applying unit 19 includes a tension bar 20 that is in contact with and presses the medium 7 and thus applies a tension T1 thereto (FIGS. 1 and 3), and a tension bar moving unit 21 that moves the tension bar 20.

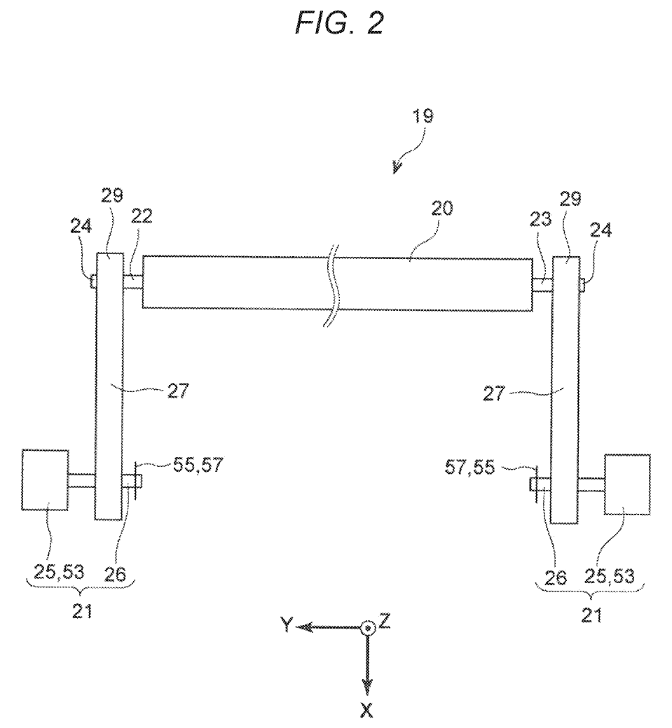

As illustrated in FIG. 2, the tension applying unit 19 is disposed at two end parts 22, 23 in the longitudinal direction of the tension bar 20. The tension bar 20 is fixed to a bar support shaft 24.

The tension bar moving unit 21 includes a rotating part 25 and a rotating shaft 26 that rotates integrally with the rotating part 25. One end part 28 of an arm part 27 is fixed to the rotating shaft 26. A distal end part 29 of the arm part 27 is a free end and is fixed to the two end parts 22, 23 of the tension bar 20. That is, when the rotating part 25 rotates, the distal end part 29 of the arm part 27 swings with the one end part 28 side serving as a swing fulcrum, and the tension bar 20 is moved by this swing.

The tension bar moving unit 21 is driven by motive power transmitted from a motor, not illustrated, according to a control signal of the control unit 15.

The medium 7 fed from the feeding unit 2 is conveyed in the conveyance direction F in a state where an extra length part 30 is formed between the roll body R1 and the conveyance unit 3. The tension bar 20 is in contact with the medium 7 at the extra length part 30 to apply the tension T1 thereto, and brings the medium 7 at the extra length part 30 into a stretched state. Specifically, the medium 7 between a guide roller 31 and a guide surface 32 located immediately before the conveyance unit 3, the guide roller 31 and the guide surface 32 forming the conveyance path 18, is in a substantially U-shaped posture via the tension bar 20.

As illustrated in FIG. 3, when the conveyance unit 3 intermittently conveys the medium 7, the tension bar 20 reciprocates up and down between a lower position PL and an upper position PT in the state where the tension T1 is applied to the medium 7 fed from the feeding unit 2.

When recording is being performed by the recording unit 4 in a state where the conveyance unit 3 is stopped, the tension bar 20 moves downward to increase the length of the medium 7 located at the extra length part 30. When recording by the recording unit 4 ends, the tension bar 20 is located at the lower position PL. At this time, the extra length part 30 has the longest length.

When the recording by the recording unit 4 is finished and the conveyance of the medium 7 by the conveyance unit 3 is resumed, the tension bar 20 starts to move upward. The conveyance unit 3 stops when the medium 7 is fed by the feeding dimension L per feed. When the conveyance unit 3 stops, the tension bar 20 is located at the upper position PT. At this time, the extra length part 30 has the shortest length. Subsequently, the tension bar 20 starts to move toward the lower position PL and then reaches the lower position PL. After that, the tension bar 20 reciprocates between the lower position PL and the upper position PT in the state where the tension T1 is applied to the medium 7, in synchronization with the intermittent conveyance of the conveyance unit 3.

The operation in which the tension bar 20 reciprocates between the lower position PL and the upper position PT in the state where the tension T1 is applied to the medium 7, in synchronization with the intermittent conveyance of the conveyance unit 3, is executed under the control of the control unit 15.

### Tension Applying Unit on Take-Up Unit Side

A tension applying unit 40 is also provided in the conveyance path 18 between the conveyance unit 3 and the take-up unit 5. The tension applying unit 40 includes a tension bar 41 that is in contact with and presses the medium 7 and thus applies a tension T2 thereto (FIG. 1), and a tension bar moving unit 42 that moves the tension bar 41.

Similarly to the tension applying unit 19, the tension applying unit 40 is disposed at two end parts in the longitudinal direction of the tension bar 41, and the tension bar 41 is fixed to a bar support shaft, not illustrated.

As in the tension applying unit 19, the tension bar moving unit 42 includes a rotating part 43 and a rotating shaft 44 that rotates integrally with the rotating part 43. One end part 46 of an arm part 45 is fixed to the rotating shaft 44. A distal end part 47 of the arm part 45 is a free end and is fixed to the two end parts of the tension bar 41. That is, when the rotating part 43 rotates, the distal end part 47 of the arm part 45 swings with the one end part 46 side serving as a swing fulcrum, and the tension bar 41 is moved up and down by this swing.

The tension bar moving unit 42 is driven by motive power transmitted from a motor, not illustrated, according to a control signal of the control unit 15.

As in the tension applying unit 19, the medium 7 on which recording is executed by the recording unit 4 is conveyed in the conveyance direction F in a state where an extra length part 48 is formed between the roll body R2 and the conveyance unit 3. The tension bar 41 is in contact with the medium 7 at the extra length part 48 to apply the tension T2 thereto, and brings the medium 7 at the extra length part 48 into a stretched state. Specifically, the medium 7 between a guide frame 49 and a guide roller 50 located immediately before the take-up unit 5, the guide frame 49 and the guide roller 50 forming the conveyance path 18, is in a substantially U-shaped posture via the tension bar 41.

When the conveyance unit 3 intermittently conveys the medium 7, the tension bar 41 reciprocates up and down between a lower position and an upper position, not illustrated, in the state where the tension T2 is applied to the medium 7 conveyed from the conveyance unit 3.

When recording is being performed by the recording unit 4 in a state where the conveyance unit 3 is stopped, the tension bar 41 moves upward to reduce the length of the medium 7 located at the extra length part 48. When recording by the recording unit 4 ends, the tension bar 41 is located at the upper position. At this time, the extra length part 48 has the shortest length.

When the recording by the recording unit 4 is finished and the conveyance of the medium 7 by the conveyance unit 3 is resumed, the tension bar 41 starts to move downward. The conveyance unit 3 stops when the medium 7 is fed by the feeding dimension L per feed. When the conveyance unit 3 stops, the tension bar 41 is located at the lower position. At this time, the extra length part 48 has the longest length. Subsequently, the tension bar 41 starts to move toward the upper position and then reaches the upper position. Thereafter, the tension bar 41 reciprocates between the lower position and the upper position in the state where the tension T2 is applied to the medium 7, in synchronization with the intermittent conveyance of the conveyance unit 3.

The operation in which the tension bar 41 reciprocates between the lower position and the upper position in the state where the tension T2 is applied to the medium 7, in synchronization with the intermittent conveyance of the conveyance unit 3, is executed under the control of the control unit 15.

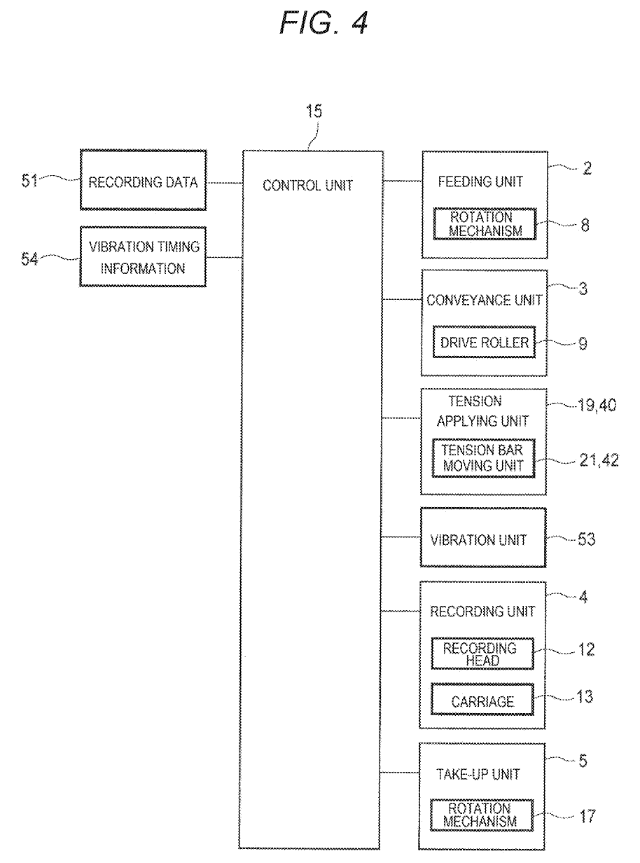

The control unit 15 is configured as shown in the block diagram of FIG. 4. That is, the control unit 15 controls each operation of the feeding unit 2, the conveyance unit 3, the recording unit 4, the take-up unit 5, and the tension bar moving units 21, 42.

Specifically, upon receiving recording data 51 (FIG. 4), the control unit 15 causes the recording unit 3 to execute the above-described recording operation. The control unit 15 causes the feeding unit 2 to execute the above-described feeding operation of the medium 7, causes the conveyance unit 3 to execute the above-described conveyance operation of the medium 7, causes the take-up unit 5 to execute the above-described winding-up operation, and causes the tension bar moving units 21, 42 to execute the tension applying operation on the medium 7.

### Embodiment 1

Next, Embodiment 1 of a conveyance device 52 according to the present disclosure will be described with reference to FIGS. 3 and 4. The conveyance device 52 according to the present embodiment is an element of the recording device 1.

The conveyance device 52 according to the present embodiment includes the feeding unit 2 that rotatably holds the roll body R1 formed of the wound medium 7 and can feed the medium 7 from the roll body R1, and the conveyance unit 3 that intermittently conveys the medium 7 fed from the roll body R1 in the conveyance direction F. The conveyance device 52 also includes the tension bar 20 that is disposed to be movable between the feeding unit 2 and the conveyance unit 3 in the conveyance path 18 along which the medium 7 is conveyed, the tension bar moving unit 21 that moves the tension bar 20, and the vibration unit 53 that vibrates the tension bar 20.

Since the structures of the feeding unit 2, the conveyance unit 3, the tension bar 20, and the tension bar moving unit 21, except the structure of the vibration unit 53, have already been described in the description of the recording device 1, the description thereof will be omitted.

In the present embodiment, the vibration unit 53 is configured such that the rotating part 25 of the tension bar moving unit 21 also functions as the vibration unit 53. That is, the vibration unit 53 is configured such that the rotating part 25 is made to move in the following manner and thus implements the function of the vibration unit 53.

The rotating shaft 26 of the rotating part 25 is moved to repeat forward rotation and reverse rotation in a short cycle. Thus, the distal end part 29 of the arm part 27 reciprocates up and down in a short cycle. Thus, the tension bar 20 also reciprocates up and down in a short cycle. As described above, as the tension bar 20 reciprocates up and down in a short cycle, the rotating part 25 implements the function of the vibration unit 53.

As illustrated in FIG. 4, the vibration unit 53 is driven by a control signal of the control unit 15.

In the present embodiment, the control unit 15 is configured to drive the vibration unit 53 to vibrate the tension bar 20, based on vibration timing information 54 designating the timing of vibrating the tension bar 20.

In many cases, when moving between the lower position PL and the upper position PT, the tension bar 20 generates an abnormal noise in a partial range between the lower position PL and the upper position PT instead of generating an abnormal noise over the entire range. Specifically, in many cases, the tension bar 20 generates an abnormal noise at a position P1 within a certain range immediately before the tension bar 20 reaches the lower position PL after starting to move downward from the upper position PT, and at a position P2 within a certain range immediately after the tension bar 20 starts to move upward from the lower position PL. Therefore, the vibration unit 53 may be driven to vibrate the tension bar 20 at the positions P1 and P2, where the tension bar 20 generates an abnormal noise. The vibration may be performed at the first position, of the positions P1 and P2, or may be performed over the entire range.

In the present embodiment, the vibration timing information 54 is position information of the moving tension bar 20. That is, the vibration timing information 54 is configured to use the position P1 and the position P2 within the range of movement of the tension bar 20. The control unit 15 drives the vibration unit 53 at the timing when the tension bar 20 is located at the position P1 and the position P2.

### Acquisition of Position Information

As shown in FIG. 2, in the present embodiment, the tension bar moving unit 21 includes the rotating part 25 and a rotary encoder 55.

The rotary encoder 55 has a rotating disk 57 having a plurality of regular slits (not shown). The rotary encoder 55 senses and counts the slits on the rotating disk 57 with an optical sensor made up of a set of a light emitting element and a light receiving element, not illustrated. The rotary encoder 55 can find the amount of rotation of the disk 57 from the number of the slits counted with the optical sensor.

In the present embodiment, since the disk 57 is fixed to the rotating shaft 26, the amount of rotation of the disk 57 is the amount of rotation of the rotating shaft 26. The tension bar 20 reciprocates between the lower position PL and the upper position PT as the arm part 27 swings due to the rotation of the rotating shaft 26. Therefore, based on the direction of rotation and the amount of rotation of the disk 57, the position information indicating where the tension bar 20 moving up and down is located within the range of movement can be acquired. That is, the rotary encoder 55 can specify whether the tension bar 20 is located at the position P1 and the position P2.

Upon receiving, via the rotary encoder 55, the timing information 54 indicating that the tension bar 20 is located at the position P1 and the position P2, where the tension bar 20 generates an abnormal noise, the control unit 15 drives the vibration unit 53 to vibrate the tension bar 20.

As illustrated in FIG. 3, in the present embodiment, a vibration transmission suppression member 56 is provided between the conveyance unit 3 and the tension bar 20. The vibration transmission suppression member 56 has a role of suppressing the transmission of vibration to the conveyance unit 3 when the tension bar 20 vibrates. Therefore, a part of the vibration transmission suppression member 56 that is in contact with the medium 7 is made of a material that absorbs vibration, such as rubber, silicone, or urethane, or a material that damps vibration.

Here, a driven roller that nips the medium 7 with the guide surface 32 is employed as the vibration transmission suppression member 56. The vibration transmission suppression member 56 is not limited to the driven roller as long as the vibration transmission suppression member 56 implements the above-described function.

### Description of Functions of Embodiment 1

Next, the functions of Embodiment 1 will be described with reference to FIG. 3.

In synchronization with the intermittent conveyance by the conveyance unit 3, the tension bar 20 repeats the up and down movement in the range of movement between the upper position PT and the lower position PL. When the tension bar 20 moves downward and passes through the position P1, the vibration timing information 54 indicating that the tension bar 20 passes through the position P1 is transmitted to the control unit 15. When the tension bar 20 starts to move upward and passes through the position P2, the vibration timing information 54 indicating that the tension bar 20 passes through the position P2 is transmitted to the control unit 15. That is, the control unit receives the vibration timing information 54 indicating that it is the timing of vibrating the tension bar 20.

Upon receiving the vibration timing information 54, the control unit 15 drives the vibration unit 53 to vibrate the tension bar 20.

### Description of Effects of Embodiment 1

(1) In the present embodiment, the conveyance device includes the tension bar 20 that is disposed to be movable between the feeding unit 2 and the conveyance unit 3 in the conveyance path 18 along which the medium 7 is conveyed, and presses the medium 7 to apply the tension T1 thereto, and the tension bar moving unit 21 that moves the tension bar 20. The conveyance device also includes the vibration unit 53 that vibrates the tension bar 20. Thus, as the vibration unit 53 vibrates the tension bar 20 when the tension bar 20 slides on the medium 7, the generation of the abnormal noise can be suppressed.

(2) Also, in the present embodiment, the control unit 15 is configured to drive the vibration unit 53 to vibrate the tension bar 20, based on the vibration timing information 54 designating the timing of vibrating the tension bar 20. Thus, the generation of the abnormal noise can be suppressed by vibrating the tension bar 20 at the timing when in the state where the abnormal sound is generated, that is, at an appropriate timing. Also, the generation of the abnormal noise can be suppressed without causing unnecessary vibration of the tension bar 20.

(3) In the present embodiment, the vibration timing information 54 is the position information P1 and P2 in the direction of movement of the moving tension bar 20. Thus, the generation of the abnormal noise can be suppressed by vibrating the tension bar 20 at an appropriate timing, based on the position information P1 and P2 of the tension bar 20.

(4) In the present embodiment, since the position information P1 and P2 is acquired via the rotary encoder 55, the position information P1 and P2 can be acquired with a simple structure.

(5) Also, in the present embodiment, since the vibration transmission suppressing member 56 is provided between the conveyance unit 3 and the tension bar 20, the transmission of the vibration to the conveyance unit 3 can be suppressed and therefore the conveyance accuracy of the conveyance unit 3 can be maintained.

### Embodiment 2

Next, the conveyance device 52 according to Embodiment 2 will be described with reference to FIGS. 2 and 3. The same parts as in Embodiment 1 are denoted by the same reference numerals and signs, and the description of the configurations of the parts and effects corresponding to the configurations is omitted.

The tension bar 20 has an acceleration area, a constant speed area, and a deceleration area as the speed when moving between the lower position PL and the upper position PT. Specifically, when the tension bar 20 starts to move downward from the upper position PT, the tension bar 20 moves through an acceleration area where the speed gradually increases, a constant speed area where the speed is constant, and a deceleration area where the speed gradually decreases. The same applies to when the tension bar 20 starts to move upward from the lower position PL.

As described above, the abnormal noise is generated at the position P1 when the tension bar 20 moves downward and the position P2 when the tension bar 20 moves upward. The discloser of the present application has confirmed that the tension bar 20 passes through the position P1 in the deceleration state and passes through the position P2 in the acceleration state. Therefore, it can be said that a speed V1 when the tension bar 20 starts to pass through the position P1 in the deceleration state can be used as the vibration timing information 54. Similarly, it can be said that a speed V2 when the tension bar 20 starts to pass through the position P2 in the acceleration state can be used as the vibration timing information 54.

That is, in the present embodiment, the vibration timing information 54 is the speed V1 and the speed V2, which are the speed information of the moving tension bar 20.

### Acquisition of Speed Information

The rotary encoder 55 can find the rotational speed of the disk 57 from the number of slits per unit time counted by the optical sensor. The rotational speed of the disk 57 has a certain relation with the moving speed of the tension bar 20.

In the present embodiment, since the disk 57 is fixed to the rotating shaft 26, the rotational speed of the disk 57 is the rotational speed of the rotating shaft 26. The tension bar 20 reciprocates between the lower position PL and the upper position PT as the arm part 27 swings due to the rotation of the rotating shaft 26. Therefore, based on the direction of rotation and the rotational speed of the disk 57, the speed information of the tension bar 20 moving up and down can be acquired. That is, the rotary encoder 55 can specify whether the tension bar 20 is at the speed V1 and the speed V2.

Upon receiving, via the rotary encoder 55, the timing information 54 indicating that the tension bar 20 is at the speed V1 and the speed V2, where the tension bar 20 generates an abnormal noise, the control unit 15 drives the vibration unit 53 to vibrate the tension bar 20.

### Description of Effects of Embodiment 2

(1) In the present embodiment, the vibration timing information 54 is the speed information V1 and V2 of the moving tension bar 20. Thus, the generation of the abnormal noise by vibrating the tension bar 20 at an appropriate timing, based on the speed information V1 and V2 of the tension bar 20.

(2) Also, in the present embodiment, since the speed information V1, V2 is acquired via the rotary encoder 55, the speed information V1, V2 can be acquired with a simple structure.

### Embodiment 3

Next, the conveyance device 52 according to Embodiment 3 will be described with reference to FIGS. 2 and 3. The same parts as in Embodiment 1 or Embodiment 2 are denoted by the same reference numerals and signs, and the description of the configurations of the parts and effects corresponding to the configurations is omitted.

In the present embodiment, the control unit 15 is configured to execute an operation of starting the downward movement of the tension bar 20 located at the upper position PT by the tension bar moving unit 21 after the conveyance unit 3 stops, and moving the tension bar 20 located at the lower position PL upward by the tension bar moving unit 21 after the conveyance unit 3 resumes the conveyance of the medium 7.

Therefore, it can be said that, by measuring a time T until the tension bar 20 reaches the position P1 after starting to move downward after the conveyance unit 3 stops moving, whether the tension bar 20 is located at the position P1 and the position P2 can be specified without using the rotary encoder 55.

Also, in the present embodiment, the control unit 15 is configured to vibrate the tension bar 20 during a first predetermined time S1 and a second predetermined time S2, described below.

(1) The first predetermined time S1 is a predetermined time after the conveyance unit 3 stops and immediately before the tension bar 20 reaches the lower position PL. The first predetermined time S1 is a length of time determined as the time when the tension bar 20 is located at the position P1, based on the measured time T.

(2) The second predetermined time S2 is a predetermined time after the conveyance unit 3 resumes the conveyance of the medium 7 and immediately after the tension bar 20 starts to move upward from the lower position PL. The second predetermined time S2 is a length of time determined as the time when the tension bar 20 is located at the position P2, based on the measured time T.

That is, in the present embodiment, the vibration timing information 54 is the first predetermined time S1 and the second predetermined time S2.

### Description of Effects of Embodiment 3

(1) In the present embodiment, the vibration timing information 54 includes (1) the first predetermined time S1 after the conveyance unit 3 stops and immediately before the tension bar 20 reaches the lower position PL, and (2) the second predetermined time S2 after the conveyance unit 3 resumes the conveyance of the medium 7 and immediately after the tension bar 20 starts to move upward from the lower position PL. Thus, the generation of the abnormal noise can be suppressed by vibrating the tension bar 20 at an appropriate timing without using the rotary encoder 55.

### Other Embodiments

The conveyance device 52 and the recording device 1 according to the present disclosure basically have the configurations according to the above-described embodiments, but as a matter of course, changes, omissions, and the like of some parts of the configurations can be made without departing from the scope of the present disclosure.

(1) In each of the above embodiments, the position information P1, P2 or the speed information V1, V2 as the vibration timing information 54 is described as being acquired via the rotary encoder 55, but the present disclosure is not limited thereto. For example, the movement of the tension bar 20 may be acquired by arithmetic processing from a moving image captured by a camera. Alternatively, the position information P1, P2 may be acquired via a position sensor such as a limit sensor.

(2) In each of the above embodiments, the rotating part 25 of the tension bar moving unit 21 is described as serving also as the vibration unit 53, but the present disclosure is not limited thereto. For example, the tension bar 20 may be vibrated using a vibration device such as a vibrator.

(3) In each of the above embodiments, the conveyance device 52 is described as an element of the recording device 1, but the conveyance device 52 is not limited to an element of the recording device 1. For example, other devices such as a transfer device may include the moving tension bar 20.

(4) The tension bar 20 may be moved along a long guide groove, not illustrated. That is, the bar support shaft 24 of the tension bar 20 may be slidably engaged with the guide groove to guide the movement of the tension bar 20.

(5) The vibration timing information 54 is preferably configured such that the user can perform an adjustment to change the vibration timing information 54 according to the state where the abnormal sound is actually generated.

(6) When the tension bar 20 moves, the vibration unit 53 may be vibrated over the entire range of the deceleration area and the acceleration area, or may be vibrated constantly or intermittently over the entire range of movement. At this time, the intensity of the vibration may be variable.

What is claimed is:

1. A conveyance device comprising:
a feeding unit configured to rotatably hold a roll body formed of a wound medium and be able to feed the medium from the roll body;
a conveyance unit configured to intermittently convey the medium fed from the roll body in a conveyance direction;
a tension bar disposed to be movable between the feeding unit and the conveyance unit in a conveyance path along which the medium is conveyed, and configured to press the medium to apply a tension thereto;
a tension bar moving unit configured to move the tension bar; and
a vibration unit configured to vibrate the tension bar.

2. The conveyance device according to claim 1, further comprising:
a control unit configured to control each operation of the feeding unit, the conveyance unit, the tension bar moving unit, and the vibration unit, wherein
the control unit drives the vibration unit to vibrate the tension bar, based on vibration timing information designating a timing of vibrating the tension bar.

3. The conveyance device according to claim 2, wherein
the vibration timing information is position information in a direction of movement of the moving tension bar.

4. The conveyance device according to claim 3, wherein
the tension bar moving unit includes
a rotating part and a rotary encoder, and
the position information is acquired via the rotary encoder.

5. The conveyance device according to claim 2, wherein
the vibration timing information is speed information of the moving tension bar.

6. The conveyance device according to claim 5, wherein
the tension bar moving unit includes
a rotating part and a rotary encoder, and
the speed information is acquired via the rotary encoder.

7. The conveyance device according to claim 2, wherein
the control unit is configured to execute an operation of starting a downward movement of the tension bar located at an upper position by the tension bar moving unit after the conveyance unit stops, and moving the tension bar located at a lower position upward by the tension bar moving unit after the conveyance unit resumes the conveyance of the medium, and
the vibration timing information is (1) a first predetermined time after the conveyance unit stops and immediately before the tension bar reaches the lower position, and (2) a second predetermined time after the conveyance unit resumes the conveyance of the medium and immediately after the tension bar starts to move upward from the lower position.

8. The conveyance device according to claim 2, wherein
a vibration transmission suppression member is provided between the conveyance unit and the tension bar.

9. A recording device comprising:
a recording unit configured to perform recording on a conveyed medium; and
a conveyance device located upstream of the recording unit in a conveyance direction and configured to convey the medium toward the recording unit, wherein
the conveyance device is the conveyance device according to claim 1.
